(19) United States
(12) Patent Application Publication
(10) Pub. No.: US 2024/0311849 A1
(43) Pub. Date: Sep. 19, 2024

(54) COMPUTERIZED METHOD AND SYSTEM FOR GENERATING A COMMEMORATIVE ITEM

(71) Applicant: Eventshop, Inc., Brentwood, TN (US)

(72) Inventors: Spencer S Combs, Brentwood, TN (US); Trey Cushman, Brentwood, TN (US); Jeremy Cowart, Brentwood, TN (US)

(21) Appl. No.: 18/677,067

(22) Filed: May 29, 2024

Related U.S. Application Data
(63) Continuation-in-part of application No. 18/437,515, filed on Feb. 9, 2024.
(60) Provisional application No. 63/444,363, filed on Feb. 9, 2023.

(51) Int. Cl. G06Q 30/018

(52) U.S. Cl. CPC G06Q 30/0185

(57) ABSTRACT

A computerized method and system provides for electronic generation of a commemorative item. The method and system includes associating, via a computing application, a user with an event. The method and system acquires event data relating to the event and generates an electronic representation of the commemorative item associated with the event. This user is granted access to the commemorative item based on the user as being associated with the event, such as confirming attendance via a ticketing platform. The method and system includes providing a physical version of the commemorative item to the user, wherein the commemorative item includes at least part of the event data printed thereon. Therein, via a mobile computing device, the method and system includes presenting at least one augmented reality display based on a video capture of the physical version of the commemorative item, display includes content associated with the event.

### RELATED APPLICATIONS

The present application is a continuation-in-part of U.S. patent application Ser. No. 18/437,515 entitled “AUGMENTED REALITY SECONDARY CONTENT SYSTEM AND METHOD” filed Feb. 9, 2024, which relates to and claims priority to U.S. Provisional Patent Application Ser. No. 63/444,363 filed Feb. 9, 2023.

### FIELD OF THE INVENTION

The invention relates generally to supplementing an existing event ticketing platform and generating an electronic and/or physical commemorative item associated with attendance at an event, as verified by the event ticketing platform.

### BACKGROUND

It is common for individuals to attend events and purchase commemorative items (e.g. t-shirt, poster, artwork, etc.). Users leaving these events are left with vivid memories and experiences, but promoters, managers, and other professionals are leaving behind huge opportunities to generate additional contact points and sharing content.

The digitization of tickets and other contact points with consumers is another area of lost opportunities for not only enhancing the fan experience, but also generating additional revenue. For instance, it was not uncommon for users to receive a physical ticket to an event. The ticket stub became a de facto souvenir. It was not uncommon for users to keep, and even memorialize, ticket stub(s) for famous events.

The digitization of electronic solutions coincides with developments of content distribution, including increasing utilization of augmented reality or other types of overlay presentations. For example, a common technique is using a quick response (QR) code for electronic navigation to a dedicated web portal on a mobile computing device. The QR code is readable by a mobile phone and then triggers accessing a dedicated web page. While QR codes offer a low-cost solution for web access and allowing the user to subsequently download content, this is not an ideal solution for commemorative items.

There is a need for improving the generation of physical commemorative items associated with events, as well as building upon existing technology to supplement or compliment user experiences.

### BRIEF DESCRIPTION

The present invention provides for generating a commemorative item associated with an event. The commemorative item can be generated both digitally and physically. In one embodiment, the commemorative item includes one or more recognizable elements for activating an augmented reality (AR) display including AR content associated with the event itself.

The method and system operates across a number of computing processing systems or environments and includes interacting with existing processing systems. In one embodiment, for generating a commemorative item, accessibility to the item can be predicated based on verified attendance to the event itself. Therefore, the method and system can include communicating with a ticketing platform for detecting and/or verifying user attendance at any event, which may include eligibility for acquiring a commemorative item.

As used herein, an event can be type of occurrence or series of occurrences worth attending. For example, one type of event can be a sporting event, such as a single game, competition, match, etc. For example, one type of event can be a performance, such as a concert, a musical, a theatrical play, an opera performance, etc. For example, one type of event can be a series of events, such as a competition season, a multi-day tournament, multi-day and/or multi-sport competition, e.g. the Olympics or one or more competitions, e.g. the women's gymnastics competition at the Olympics. Events can also be access by visitors to a special location and/or for a special event, for example visiting an amusement park, a zoo, a graduation, and/or any other unique destination or event. The above examples are not limiting in nature, but generally defined herein, an event can be any type of singular or multiple occurrence where a user or groups of users attend, watch, or otherwise engaged in viewing, listening, and/or active participation.

The method and system, with user attendance verified, generates an electronic version of the commemorative item. This electronic version can be a graphical representation showing details associated with the event, including but not limited to, logos, date, time, location, etc.

The method and system can additionally interact with another computing system that collects event data. Event data represents any data associated with or occurring at the event. In an example where the event is a hockey game, the event data can represent statistics associated with the event, such as the final score, ice time for various players, records of who scored during the game, saves, shots-on-goal, etc. Event data is not expressly limited to statistic of the event itself, but can also represent other events occurring during the event. In the above example of a hockey game, one embodiment of event data can include information associated with a retirement presentation, retiring a particular jersey and/or honoring a teammate, former teammate, etc.

The method and system, via a user interface, provides the user with a view of the electronic commemorative item and option(s) for purchasing a physical version. Moreover, the electronic commemorative item can include event data printed thereon, including printing information about the date of the event, the final score, and statistics about the game. The event data can be personal to the user, for example a seat location within the venue, data of access, time of entrance, etc.

In response to a user purchasing a physical version, the method and system includes generating a physical commemorative item and distributing the item to the user. In the example of the hockey game, the physical commemorative item can be a physical item taking the look and shape of a physical ticket used for access to the event. The ticket can include the event data printed thereon.

In one embodiment, via a mobile computing device, the user can then access AR content made available by the physical commemorative item. For example, using an AR application on the mobile device, the application uses the camera to recognize the physical commemorative item and launch an AR display. The AR display can overlay imagery of highlights from the event, for example displaying a game-winning goal, a jersey retirement ceremony, etc.

Herein, the method and system uses ticketing software to verify attendance, data gathering techniques for collecting event data, processing routines to generate commemorative items, and in some embodiments using AR technology to improve and compliment user experiences.

### BRIEF DESCRIPTION OF THE DRAWING

The invention will be described with respect to the following drawing figures, in which like numerals represent like features throughout the description, and in which:

FIG. 1 illustrates one embodiment of a processing environment for generating a commemorative item;

FIG. 2 illustrates a flowchart of steps of one embodiment of a method for generating a commemorative item;

FIG. 3 illustrates a representation of an AR viewer application usable with the commemorative item;

FIG. 4 illustrates a schematic diagram of a processing system;

FIG. 5 illustrates a schematic diagram of one embodiment of a mobile computing device;

FIG. 6 illustrates a schematic diagram of one embodiment of a network processing system;

FIG. 7 illustrates a flowchart of the steps of one embodiment of a method for augmented reality distribution;

FIG. 8 is a flowchart of multiple interactive embodiments for user engagement, content distribution and content management within the augmented reality distribution system;

FIG. 9 is a sample illustration of item recognition;

FIG. 10 is a sample illustration of AR content overlay;

FIG. 11 is a sample illustration of item recognition; and

FIG. 12 is a sample illustration of AR content overlay.

### DETAILED DESCRIPTION

The present method and system improves upon user engagement experiences by including additional contact points and memorabilia for fans.

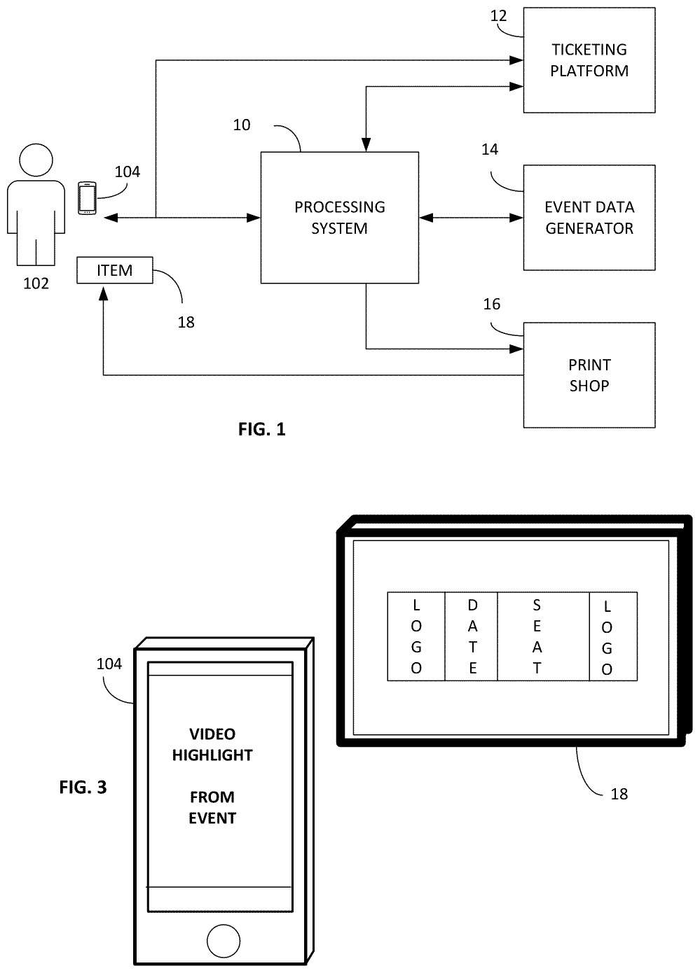

FIG. 1 illustrates one embodiment of a computing system providing for generating commemorative item(s). The system includes processing system 10, operative to perform processing operations in response to executable instructions. The system 10 engages with a ticketing platform 12, as well as an event data generator 14. The system 10 can further engage with a print shop 16 for generating a physical commemorative item 18.

The processing system 10 can be a single processing system, for example disposed on a dedicated server or other network location, or can be plurality of processing modules disposed across one or more separate processing environments. The system 10 operates by performing operations as noted herein.

The ticketing platform 12 can be any suitable ticketing software or other processing system for managing tickets or other access to an event. For example, in one embodiment may be a third-party vendor system for users to electronically purchase tickets, receive electronic versions of said tickets, and the present electronic versions for entrance to an event. As described in greater detail below, the processing system 10 operates not as a platform for managing user access to events, but instead uses the platform 12 for verifying access to an event, as well collecting user information associated with the event. The ticketing platform 12 can be a third-party vendor system or can be one element of the general commemorative item system.

The event data generator 14 generally represents one or more systems that collect event data. Event data generally refers to any information associated with an event. In the example of the event being a sporting event, event data can include player statistics. Event data can also relate to occurrences related to the event, for example special ceremonies or third-party events, including for example but not limited to ceremonies honoring special players/athletes, award presentations to teams and/or players, concerts occurring before or after an event, etc. Event data can be in any suitable form, including text data, video data, audio data, image data, by way of example.

The event data generator 114 can be any system that collects event data. For example, in-game statistics may be captured and tallied by a managing league or association or by a third-party vendor. Event data generator 114 can be a production company generating audio and/or video of the event, for example a broadcast company generating a television broadcast and/or a radio broadcast. In another embodiment, the event data generator 114 can be a photography company or photographer generating still frame images captured during or in relation to the event.

As used herein, event data generally relates to any data associated with an event, where said event data is captured and made available including by one or more third-parties. Moreover, while the event data generator 14 may be a third-party vendor, a further embodiment may include the generator 14 as part of the same processing system 10 as it is not expressly required to be a separate company, vendor, data engine, etc.

The print shop 16 is a general term referring to any manufacturing system or vendor capable of generating a physical version of a commemorative item. In one example where the commemorative item is a replica of a physical ticket, the print shop 16 can include printers for generating the physical ticket. In another example, the commemorative item can be integrated with a frame or case, thus the print shop 16 can include assembly of the physical commemorative item 18 for distribution to the user 102.

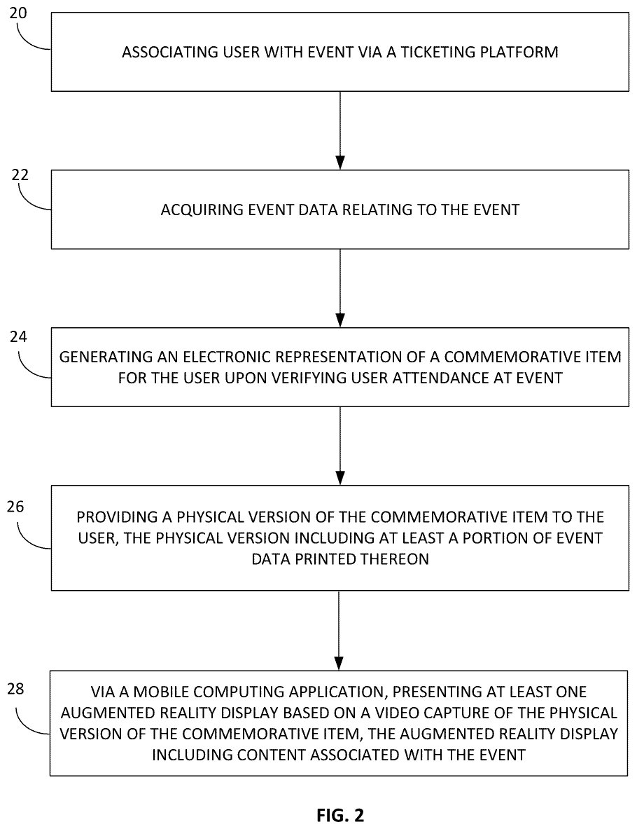

In FIG. 1, the user 102 can be someone who attended the event or someone associated with the user who attended the event. The user 102 uses a mobile computing device 104, which is illustrated as a smart phone, but can be any suitable processing device including a tablet computer, laptop computer, desktop computer, or other processing system as recognized by a skilled artisan.

Where FIG. 1 illustrates one embodiment of the present system, FIG. 2 illustrates a flowchart of steps of one embodiment of a method for generating a commemorative item.

Step 20 is associating a user with the event via a ticketing platform. The step of associating can include any number of varying embodiments. In one embodiment, associating includes verifying the user attended the event. This may include an API or other processing module transmitting an authentication value to the processing system 10 verifying the actual ticket was scanned and the user attended the event. In another embodiment, associating includes verifying the user purchased the original ticket and thus has or had legitimate access to the event, where here verification is based on purchase or receipt of a ticket and is not expressly limited to just whether the user actually attended the event.

For example, a first user may be a father purchasing a ticket to an event, e.g. a boy band musical act, where the father is not intended to the attend the event. The ticket may be for a second user, a daughter and mother, to attend the concert. Here, the processing system 10 can verify the first user (father) for purchasing and the second user (daughter) for attending. Such that verification can be predicated one purchasing, attending, or both.

In one embodiment, associating the user with the event can include additional ticketing or event information. For example, the ticketing platform 12 may provide or verify a time and date of the event, and the user's seating location at the event. Where the user purchased multiple tickets, the user verification can be associated with the person who purchased the ticket(s) and/or associated with a person or account, e.g. email account, for receipt and/or presentation of the ticket. For example, if a single person purchases 4 tickets for family members with all 4 tickets sitting next to each other, the user verification can associate all 4 tickets to the purchaser or can be assigned or allocated to individual family members who took specific seats.

Step 22 is acquiring event data relating to the event. This can include accessing third-party data collection system(s) and/or receiving incoming data. This can also include accessing linked content, for examples links to image(s), video(s) and/or audio segment(s) hosted on an external site. This can include receiving video and/or audio files of highlights or other occurrences from the event. Event data may further include image file(s), including for example logos or special images, for example if the event included honoring a specific athlete, the event data may include an image of the player's jersey, an image of the player themselves, and/or an action image or video of the player.

Step 24 is generating an electronic representation of a commemorative item. For example, this can include generating a graphical image of a ticket, having logo and event details on a front side and an image or text on the backside. In the example of a hockey game that includes a retirement presentation honoring a famous player, the front of the electronic ticket can include the team's logo, the hockey league logo, the date and time of the event, the user's seat location, and the name or logo of the competition. The back of the electronic ticket can include an image of the player's jersey and text indicating the ceremony honoring the player.

This electronic ticket can be electronically generated using an image generation application and including the event data thereon. The electronic ticket can be dynamically generated based on ticket assembly routines or instructions, with inclusion of user-specific data, such as the seat locations. The electronic ticket can be manually generated, or at the minimum the general layout is manually generated and then personalized for each user based on the ticketing application data, including verifying attendance or entitled to electronic ticket. In this example, all tickets may have an identical make-up but for different aisle/seat/section fields unique to the authenticated user.

In one embodiment, presentation of the electronic representation of the commemorative item can be part of a commercial interface ahead of a commercial transaction. For example, presenting the electronic item can be within the context of a commercial interface presented to the user, including options to purchase a physical version of the item, as well as any accompanying items such as a frame or holder. The purchasing transaction can also include the physical item being available in different formats, ranging from a standard paper ticket, to a premium bonded ticket, to a decorative foiled ticket, to a high-gloss plastics, to a metal-based physical ticket, and/or a combination of varying formats and design elements, by ways of example.

Access to the commemorative item, in one embodiment, is predicated on the user being granted access to the commercial transaction based verifying attendance at the event. Therefore, in this embodiment, the exclusivity of the commemorative item is increased because access is limited to individuals who were in actual attendance or the minimum purchased a ticket to the event.

In one embodiment, the user may access an interface to modify or otherwise edit the electronic representation of the commemorative item. For example, the user may enter specific text on the backside of the ticket.

In varying embodiments, the processing system 10 and/or the ticketing platform 12 can include further user account data management activities associated with the ticketing activities. For example, the system 10 may include a user account that includes a list of various events for which the user has purchased tickets and/or attended. In one embodiment, these tickets can be segmented by any suitable order or technique, including by date, teams, event type, among others.

Here, the user can access the system 10 and/or ticketing platform 12 to select a particular event. For example, one embodiment may include a pull-down menu that lists the event name, date, and seat details. The user activates the pull-down menu, scrolls, and selects one of the events. This event selection is then used for selecting which commemorative ticket is to be presented within a graphical user interface display.

Therefore, providing a user interface includes processing functionality at the system 10 and/or platform 12 for capturing the user events eligible for commemorative tickets. One embodiment can include one or more databases having structured data stored therein designating user accounts with ticket purchases and/or attendance verified via the platform 12. This data is then accessible via executable operations for propagating appropriate graphic user interface displays, menus, windows, or other interactive features.

Therefore, in one embodiment the commemorative ticket may be directly associated with a user and an event. In another embodiment, the user may access an account and have the ability to select from a variety of different commemorative ticket options.

Where the user completes the purchase, step 26 is providing a physical version of the commemorative item to the user. As noted in FIG. 1, the print shop 16 receives instructions to print or otherwise manufacture a physical version of the item. This print shop 16 can be an external manufacturer or within the commemorative item generation system.

In one embodiment, the processing system 10, in response to user commercial instructions, can provide the manufacturing instructions to the print shop. For example, in one embodiment a first user can select a paper ticket to be encased in a glass frame. The print shop then prints the paper ticket and assembles the ticket within the frame. For example, a second user can select a metal ticket and a wooden ticket holder. The print shop then prints or engraves the ticket.

As part of the transaction, the user 102 can present a shipping address, such that the print shop 16 can then ship the physical item 18.

In one embodiment, the method includes steps 20-26. This embodiment provides for generating a physical commemorative item based on ticketing system verification and event data relating to the event.

In one embodiment, the step 24 generating the electronic representation can be performed outside of a commercial transaction to the user via a user interface. For example, a physical commemorative item may be presented to users as part of the user experience, the purchase or request for a physical item may be made at the time of the event ticket purchase, whereas herein the electronic representation can be the formatting or printing instructions usable for the print shop (16 of FIG. 1) for generating the physical item and step 24 does not expressly require the user acquiring the commemorative item to interact with the electronic item prior to receipt of the physical item.

In addition to receipt of the physical commemorative item 18, the item itself acts as a foundation for enabling AR content. In step 28, via a mobile computing application, the method includes presenting at least one AR display based on a video capture of the physical version of the commemorative item. The AR content can include content associated with the event.

As part of the AR content, the processing system 10 can include generating AR content based on the event data. This AR content can include displaying event data, showing highlights from the event, as well as any other suitable content. Using the above example of a hockey game having a player retirement ceremony, the AR content, triggered by the physical commemorative item, can include a curated highlight reel of the player as well video clips or a retransmission of the retirement ceremony.

For further illustration, FIG. 3 illustrates one embodiment of a physical commemorative item 18 being a frame copy of the event ticket. In this example, the ticket includes logo information, date of the event, and the user's seat information. The date of the event and the seat information can be based on the information from the ticketing platform 12 of FIG. 1.

The processing device 104 can execute an AR application, as described in greater detail below. Using AR image recognition, the processing device 104 then generates the AR display showing video highlights from the event. With reference back to FIG. 1, the AR content can be provided by or made available from the processing system 10. In further embodiments, the AR content can be from any other suitable source or sources.

Wherein above examples of events include sporting events, other types of within the scope herein. For instance, if a user visits an amusement park, while that park may operate 365 days a year, for the visitor, that specific visit is an event. That amusement park visit can use a ticketing application for verifying the user. The event data can include information associated with the park, including the date, time of day user entered the park, potential rides if electronically tracked, weather conditions, etc. The AR content can include imagery of the user at the park acquired by the park itself, for example commemorative pictures with characters, action shots from rides, standard pictures/audio/video of the park and/or rides and/or characters, etc.

Another example of an event may be a multi-day or multi-event gathering, such as World Games, Olympics, Soccer World Cup, Olympic Trials, etc. In these examples, ticketing applications track and monitor user access to and attending at events, where the commemorative items can correspond to specific events, for example a Women's Team Gymnastics Final event, or broader context of events, for example multi-day Track and Field competitions.

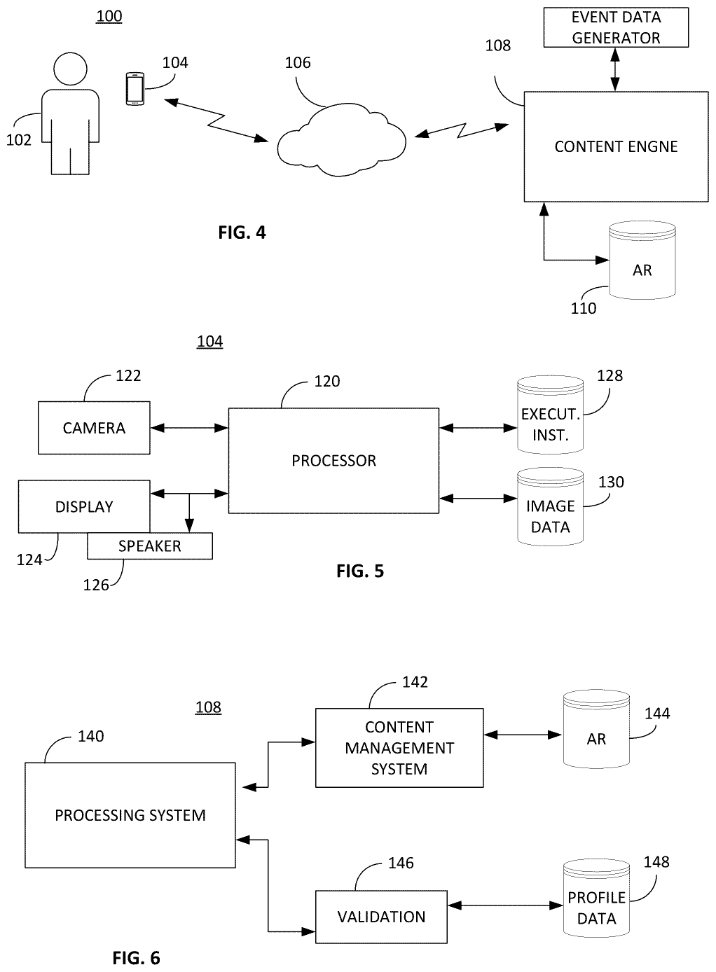

FIG. 4 is a schematic diagram of a system providing for augmented reality secondary content. The system 100 includes a user 102 with a mobile computing device 104 having network access. The network 106 provides communication with a network-based content engine 108, having AR content, as secondary content, associated therewith.

The user 102 is any individual or group of users. In one embodiment, the user attends or associated with a primary event, the primary event being, for instance, a particular event and/or being a fan of a team, performer, band, etc. The secondary content compliments the interest of the user and relates to the primary event. For instance, if the user is a fan of a particular musical group, the secondary content can be performance footage of the group.

The mobile computing device 104 can be any suitable type of mobile computing device, including but not limited to a smartphone, tablet computer, AR glasses or other type AR system or headset, laptop or desktop computer, gaming system, etc. In a typical embodiment, the mobile computing device 104 is a smart phone or tablet computer having processing elements for executing applications therein.

The network 106 can be one more wired and/or wireless networks, otherwise generally referred to as the Internet. For example, a mobile phone may connect via a wireless hotspot using a wi-fi connection through a router connected to a wired network connection. For example, a mobile phone may connect via a cellular network as a gateway.

The network-based content engine 108 can be disposed within a central or distributed network processing environment. For example, the engine 108 can be within a dedicated network server or can be distributed across a web service provider. On the network-side, the content database can be one or more data storage elements having secondary content stored therein, also referred herein as a secondary content database. As described in greater detail below, this data can be specifically generated for AR distribution or can be content managed and/or transformed for AR distribution.

FIG. 5 illustrates one embodiment of the processing within the mobile computing device 104. The mobile device 104 includes a local processor 120, camera 122, display 124, speaker 126, executable instruction storage 128, and image storage 130.

The executable instructions within the storage 128 can include application instructions, otherwise referred to as an app. In one embodiment, the user can download the app to the mobile device and launch or execute the application via the display 124. The storage is a non-transitory computer readable storage medium for storing executable instructions of the application therein.

The display 124 can be both an input and output device, for example a touchscreen. The speaker 126 can local or Bluetooth. Further embodiments are within the scope of the invention as recognized by a skilled artisan, for example display 124 and speaker 126 can be on a secondary display such using a mirroring function or other wired or wireless distribution for output content.

The application executes on the processor 120 for performing operations as noted herein. For example, in one embodiment, the application can be downloaded from a network-based repository such as an application store. The application can include accessing and using various input and output elements of the mobile processing device 104, for example using the camera 122 for image capture, the processor 120 for processing operations, and display 124, speaker 126 for output operations.

The image data, also referred to as secondary content, stored in the database 130 can be transmitted across the network 106 and processed for output via the display 124 and speaker 126. In one embodiment, the image data includes AR content visible in an AR overlay viewer. In other embodiments, the image data can be flat or 2D imagery such as a static picture or a video, such as simply being visible on the display 124 but not integrated into a formal AR viewer format.

The image data can also be transitory, locally stored as part of the viewing process but not permanently locally stored. In another embodiment, the content can be locally stored and access to viewing the content can be monitored or triggered by external factors, therefore enabling AR content display without requiring the mobile device to be actively connected to an external network.

FIG. 6 illustrates one embodiment of the network side, including content engine 108. The engine includes a processing system 140 may be one or more processing devices for receiving content requests from the applications running on the mobile devices.

This embodiment includes a content management system 142 for receiving, managing, and distributing authorized secondary content. This system 142 communicates with at least one AR content database 144. The AR content database includes the content transmitted to the mobile device 102 of FIG. 5. For instance, a musical artist may generate a video thanking fans for attending a recent concert and upload the video as secondary content to the database 144.

This embodiment further includes a validation module 146 in communication with a profile data database 148 having user profile data stored therein. The validation module 146 provides for authenticating the user and validating the user is authorized for receiving or viewing the image data from the database 144.

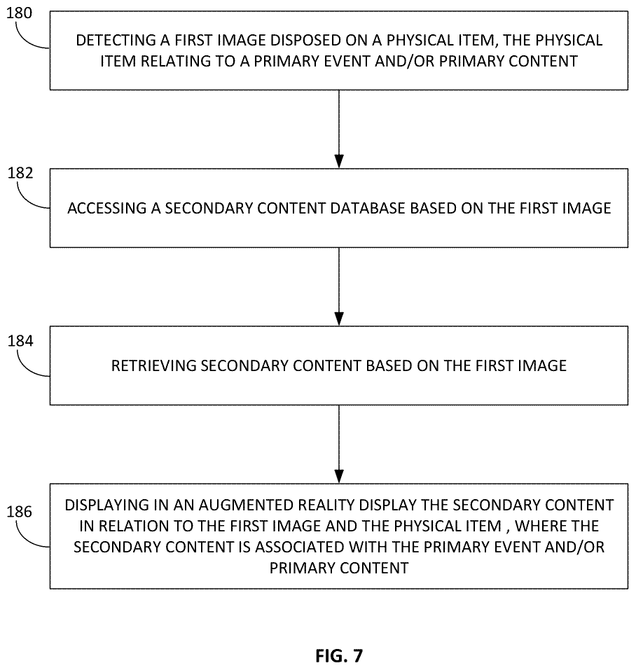

The elements of FIGS. 4-6 are illustrative in nature and not an exhaustive or exclusive list of software and processing elements. The present invention includes variations in these elements as recognized by a skilled artisan

Where FIGS. 4-6 illustrate various embodiments and elements of an augmented reality content distribution system, FIG. 7 is a flowchart of the steps of one embodiment. These operations steps may be performed by the user's processing device capable of providing augmented reality display, for example a mobile phone, laptop computer, video game console system, AR headsets, AR glasses, etc.

Step 180 is detecting a first image disposed on a physical item, the physical item relating to a primary event and/or primary content. In one example, the physical item can be a t-shirt from a concert, the t-shirt having the band's name/logo and information about the current tour. In this example, the t-shirt relates to the primary event being the concert and/or the primary content being the user's experience while at the concert. The detecting of the first image can be performed by the application using the camera viewing the t-shirt and the logo. Whereas prior art solutions used QR codes to generate a response by a browser application, in the present method and system the application can use the physical item for detection, while imagery or other elements of the physical item as the triggering event for recognition of the item and subsequent AR overlay initiation.

When executed by the application, the detection operation can trigger a network data call. Step 182 is accessing a secondary content database based on the first image. Using the above example, the image of the band's logo and concert image is detected and leads to a specific data call.

Step 184 is retrieving secondary content based on the first image. This retrieval can including a network-based data call from the application via a content server and one or more content databases. The data call can include retrieval or other identifier information, including if needed authentication information to validate the recipient is entitled to receive the content. This secondary content is formatted or otherwise available for presentation in an augmented reality output display.

Retrieval operations of step 184 can include additional back-end processing operations as noted herein. For example, digital rights management operations can include authentication or verification of authorization for content distribution, as well as an renumeration or other licensing pay-outs as part of the system and method.

Step 186 is displaying, on an output display of the mobile computing device, the secondary content in an augmented reality display in relation to the first image and the physical item. Herein, the secondary content is related to the primary event and/or primary content. For example, as described in greater detail below, a primary event may be a concert and the secondary content can be a video from the band thanking them for attending the event, an audio/visual highlight reel of the event, etc. Moreover the display of the AR content in relation to the item can be any suitable type of display, including in one embodiment having the secondary content visible as an overlay over the item itself or in amount embodiment having the secondary content generally visible in an AR environment, for example coming out of a floor, desk or operating in a general space and not specifically tied to the item itself.

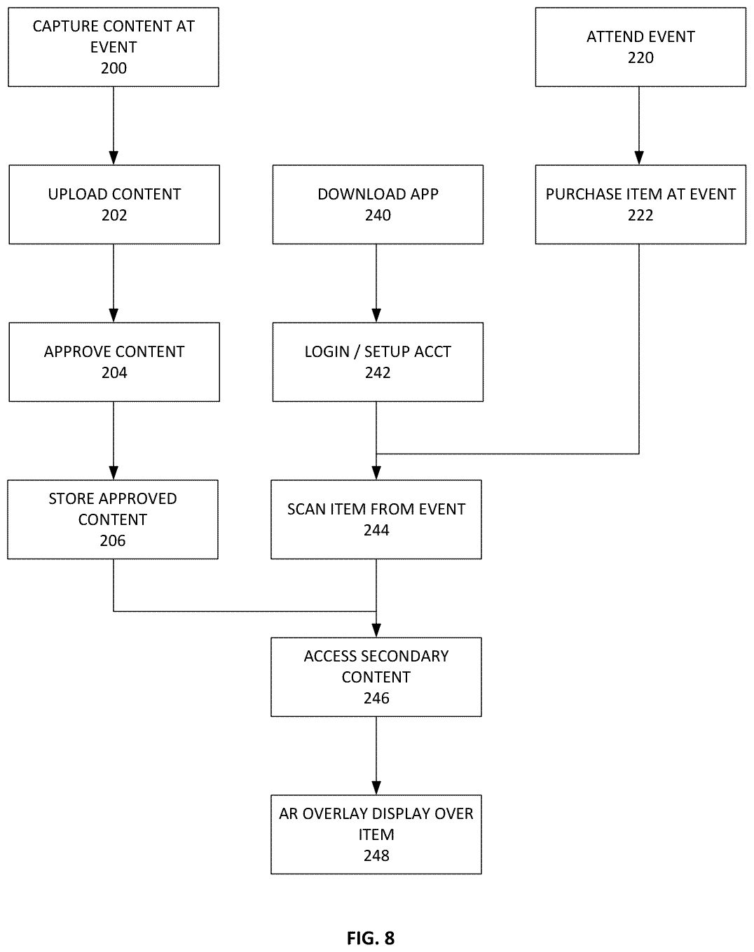

FIG. 8 flowchart of steps of varying embodiments of a method for providing secondary content complimenting a user experience.

The methodology can include 3 convergent sequences of events. A first sequence is capturing or generating content for distribution to users. The generation and management of content can be consistent with the methodology of co-pending patent application Ser. No. 18/095,562 entitled “VISUAL CONTENT MANAGEMENT AND DISTRIBUTION SYSTEM AND METHOD” the entirety of which is hereby incorporated by reference.

Step 200 is capturing content at an event. One example may be photographers capturing pictures and video at a concert. One example may be cameras recording a sporting event. This content capture does not necessarily have to specifically be at or from the event, but can be associated with aspects of the event. For example, content can be a recording session for a band or artist, a team's practice session for a sporting event, a personal message from a famous artist or athlete, by way of example.

Step 202 is uploading the content. In one embodiment, the content management system 142 of FIG. 6 receives and manages the uploaded content. This can include tracking information on various legal rights, as well as information about the content itself.

Step 204 can include authorizing content. This authorization can include any variety of steps, including authorization from an author, from the subject of the content, from control organization(s), or any other types of authorization. Authorization can also be directed to specifying the person or persons authorized by view the content, for example restricting content for not viewable by the public at large but rather a designated subset of viewers, e.g. fans with registered accounts.

Step 206 is storing the approved content. This may be stored in the database 144 of FIG. 6.

A secondary sequence of events relate to the fan or user. Step 220 is attending the event itself. For example, if the event is a concert or sporting event, the user may purchase a ticket and physically attend the event. For example, if the event is a virtual event, the user may register and login or otherwise participate via an online application, such as an in-game event for a video game or viewing a launch or release event online.

In one embodiment, step 222 is purchasing an item at the event. In a typical embodiment, the item can be a physical item that includes a logo or other identifying indicia thereon. Examples can include t-shirts, keychains, posters, framed art work, sweatshirts, cups, among other types of merchandise. Here, the user leaves the event with a souvenir, the present method and system transforms that souvenir into a AR content delivery platform.

Further embodiments do not require attendance or purchase for association with an event or content. For example, if a user is a member of a fan club, the fan club can include a poster or other identifier. The user can receive the item, the item itself then usable as the detected first image for secondary content. Another example can be a user purchasing or acquiring physical or online content, such as purchasing a compact disc, vinyl record, purchasing via a music service, etc.

In the third concurrent methodology, step 240 is the user downloading an app on their mobile device. The app can be downloaded from a mobile store or other location. In one embodiment, the user is directed to a download location, such as an app store. The user can be directed via a QR code or other indicia included with the sale of the device, for example a QR code placed on the product hang tag. In another embodiment, accessing the application can be part of the user experience visiting the event, such as a QR code being displayed on a large screen at the event. Any suitable technique can be used to direct the user for acquiring the application.

Once downloaded and locally installed, step 242 is the user either logging in or setting up an account. In one embodiment, the secondary content to be distributed to the user can be controlled by requiring the user to activate the account and provide personal information. This information can be used to track user interactions. This information can be used to verify access to the information such as verifying the user attended the event. This information can also be used to collect personal information, usable for back-end processing including generating loyalty or other content-specific program(s).

The user, once granted access via login, then scans the item using the mobile device. For example, with a mobile phone, the user may hold the phone over a concert t-shirt. In one embodiment, the application uses image recognition processing routines to detect the logo on the t-shirt.

Once the item is recognized, the application can then reference associated secondary connect. In the example of a concert t-shirt, the secondary content can be a practice session clip of the band warming up before the concert or an acoustic version of a popular song, for example.

Step 246 is accessing the secondary content. In one embodiment, the content may be locally stored in a local memory device with permission granted upon both login and recognition of the item. In one embodiment, the content may be stored across a network connection, such generating a network data call to retrieve content.

Step 248 is to generate an AR overlay display over the selected item. Consistent with AR technology, the secondary content is visible within the contours of the item. In the example of the t-shirt, the AR content displays the output over the screen display of the t-shirt. Varying AR embodiments can include zooming and adjustment techniques, including moving the mobile device to adjust the AR output display.

Varying AR embodiments can include additional interactions with the secondary content. These can include navigating between content types using a touchscreen interface, in one embodiment. For example, the content may be a selection of videos and the user is able to manually navigate or scroll between the videos such as using a swiping function on the touchscreen interface. In varying embodiments, the AR content including a selection of AR videos can include all videos downloaded and interacted from a local-storage, a network-based data transmission, or a combination thereof.

Herein, the method and system uses item recognition operations executed in a mobile device as an acquisition trigger to acquire and thus display secondary content. Access to the content is targeted based on association with the item and related events or performers associated with the item. Fans can enjoy extra content to compliment their in-person experience, transforming the souvenir into an interactive platform for additional fan content.

The back-end system can store any number of AR content for distribution to the user. The selected content for distribution can be determined using any number of suitable techniques, including subscription services where new secondary content is made available on a periodic basis in response to a subscription fee. For example, a user may receive none or a limited number of secondary AR content items with an initial purchase or registration, but additional content can be purchased or subscribed. In one example, a fan may subscribe to hear about the band's on-going tour and for a subscription payment can receive weekly messages or other related content.

Another distribution technique can be promotional content periodically transmitted in response to different events or promotional campaigns. Another distribution technique can be user-specific or time-based contents such as general content associated with attending a concert; a thank you message from the artist several days after the concert; and complimentary content at time periods thereafter.

In one embodiment, content distribution can be associated with the user or the user's association. For example if the user is a member of a specific fan club, that user may receive additional secondary content. In another example, the user may receive a timely birthday message or other special message, based on user identification data associated with the mobile viewer application.

Herein, the secondary content can be specific to a particular event, e.g. concert, sporting event, etc., and/or can be specific to particular content, e.g. an album release, a movie release, etc.

The back-end system can additionally coordinate or compliment financial transactions associated with the secondary content. For example, the user attends a concert for her favorite singer, purchases a poster, and then views content from the concert itself to re-enjoy the event. While enjoying the event, a still image from the secondary content can be made available for printing on a poster, t-shirt, sweatshirt, or other item, Therefore, the back-end system can enable communication with the commercial transaction platform with the selected image, in one embodiment using the user data to help consummate the transaction.

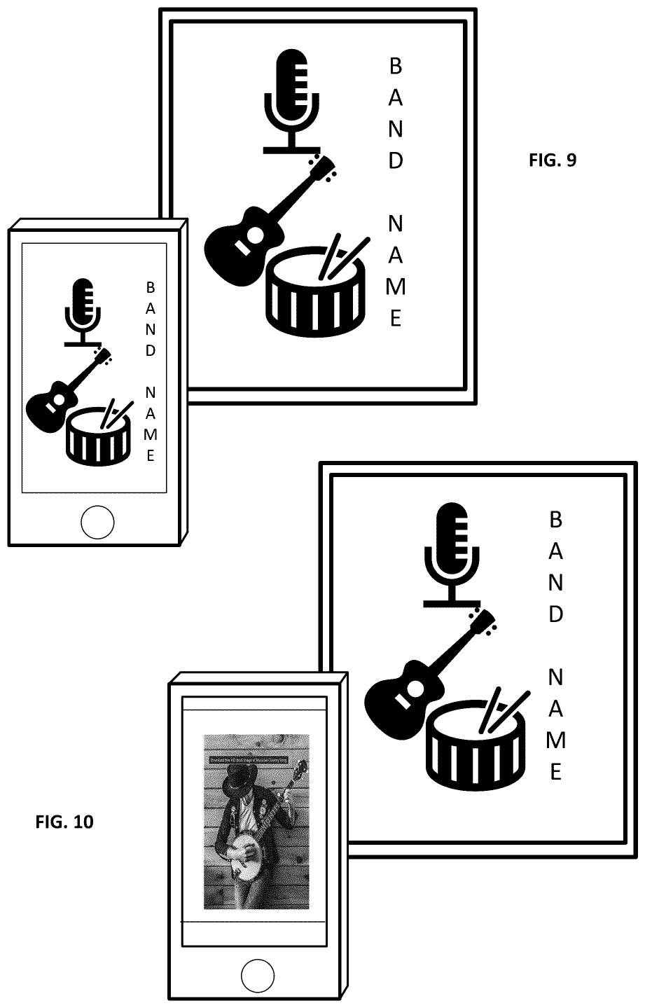

By way of example, FIG. 9 illustrates an example of the item being a framed picture of a band logo. The mobile device executes the application and uses the camera to capture the display of the framed picture. In FIG. 10, the mobile device then generates a secondary display of a video of the band leader performing an acoustic version of a song. This mobile device display is in the AR overlay.

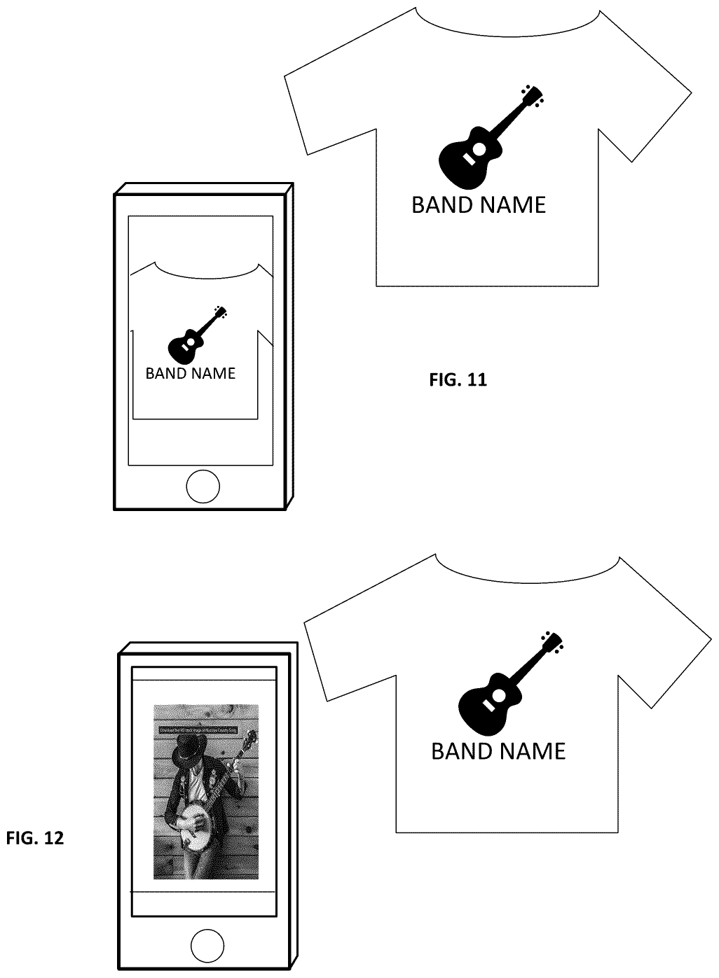

By way of example, FIG. 11 illustrates the item being a t-shirt with the band name. The mobile application recognizes the shirt and FIG. 12 is another example of AR secondary content.

While the invention has been described with respect to certain embodiments, the description is intended to be exemplary, rather than limiting. Modifications and changes may be made within the scope of the invention.

FIGS. 1-12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. As used herein, executable operations and executable instructions can be performed based on transmission to one or more processing devices via storage in a non-transitory computer readable medium.

What is claimed is:

1. A computerized method for electronic generation of a commemorative item, the method comprising:
associating, via a computing application, a user with an event;
acquiring event data relating to the event;
generating an electronic representation of the commemorative item associated with the event based on the user as being associated with the event; and
providing a physical version of the commemorative item to the user, wherein the commemorative item includes at least part of the event data printed thereon.

2. The computerized method of claim 1, wherein associating the user with the event includes verifying attendance at the event.

3. The computerized method of claim 2 wherein the providing the physical version of the commemorative is item is predicated on the verifying attendance at the event.

4. The computerized method of claim 1 further comprising:
determining a group hosting or otherwise associated with the event, the group having at least one logo; and
inserting the at least one logo on the commemorative item.

5. The computerized method of claim 1, wherein the event is a sporting event and the event data includes a plurality of statistics of event gameplay.

6. The computerized method of claim 5, wherein the physical version of the commemorative item mirrors a physical ticket to the sporting event having at least of portion of the event data printed thereon.

7. The computerized method of claim 1, further comprising:
via a mobile computing device, presenting at least one augmented reality display based on a video capture of the physical version of the commemorative item, wherein the augmented reality display includes content associated with the event.

8. The computerized method of claim 7 further comprising:
providing to the user an augmented reality application for execution on the mobile computing device by the user; and
transmitting the content associated with the event to the mobile computing device for the augmented reality display thereon.

9. The computerized method of claim 1 further comprising:
presenting to the user, via a consumer interface, a plurality of versions of the commemorative items; and
receiving a user selection of at least one of the plurality of versions of the commemorative items such that the physical version of the commemorative item is generated based thereon.

10. A computerized method for electronic generation of a commemorative item, the method comprising:
associating, via a computing application, a user with an event;
acquiring event data relating to the event;
generating an electronic representation of the commemorative item associated with the event based on the user as being associated with the event;
providing a physical version of the commemorative item to the user, wherein the commemorative item includes at least part of the event data printed thereon; and
via a mobile computing device, presenting at least one augmented reality display based on a video capture of the physical version of the commemorative item, wherein the augmented reality display includes content associated with the event.

11. The computerized method of claim 10, wherein associating the user with the event includes verifying attendance at the event.

12. The computerized method of claim 10, wherein verifying attendance is performed via an event ticket software application.

13. The computerized method of claim 10 wherein the providing the physical version of the commemorative is item is predicated on the verifying attendance at the event.

14. The computerized method of claim 10, wherein the event data is data associated with activities performed or achieved by a third party during a course of the event.

15. The computerized method of claim 10 further comprising:
determining a group hosting or otherwise associated with the event, the group having at least one logo; and
inserting the at least one logo on the commemorative item.

16. The computerized method of claim 10 further comprising:
providing to the user an augmented reality application for execution on the mobile computing device by the user; and
transmitting the content associated with the event to the mobile computing device for the augmented reality display thereon.

17. The computerized method of claim 10, wherein the event is a sporting event and the event data includes a plurality of statistics of event gameplay and wherein the physical version of the commemorative item mirrors a physical ticket to the sporting event having at least of portion of the event data printed thereon.

18. The computerized method of claim 17, wherein the content of the augmented reality display includes at least one visual highlight of a physical activity occurring at the sporting event.

19. A system for generating a commemorative item, the system comprising:
a first computer readable medium having first executable instructions stored therein;
a first processing device, in response to the first executable instructions, operative to:
associate a user with an event;
acquire event data relating to the event;
generate an electronic representation of the commemorative item associated with the event based on the user as being associated with the event; and
generating manufacturing instructions to a manufacturing device to generate a physical version of the commemorative item and distribution of the physical version of the commemorative item to the user, wherein the commemorative item includes at least part of the event data printed thereon;
a second computer readable medium having second executable instructions stored therein; and
a second processing device, disposed within a mobile computing device, in response to the second executable instructions, operative to:
present at least one augmented reality display based on a video capture of the physical version of the commemorative item, wherein the augmented reality display includes content associated with the event.

20. The system of claim 19, wherein associating the user with the event includes verifying attendance at the event using a third-party event ticket software application.

21. The system of claim 19, wherein the distribution of the physical version of the commemorative item is predicated on the verifying attendance at the event.

22. The system of claim 19, wherein the event data is data associated with activities performed or achieved by a third party during a course of the event.

23. The system of claim 19, wherein the event is a sporting event and the content of the augmented reality display includes at least one visual highlight of a physical activity occurring at the sporting event.

24. The system of claim 19, the first computing device, in response to the first executable instructions, further operative to:
present to the user, via a consumer interface, a plurality of versions of the commemorative items; and
receive a user selection of at least one of the plurality of versions of the commemorative items such that the physical version of the commemorative item is generated based thereon.
